(19) United States
(12) Patent Application Publication
(10) Pub. No.: US 2015/0126663 A1
(43) Pub. Date: May 7, 2015

(54) Tribological aromatic polyimide compositions

(71) Applicant: SOLVAY SPECIALTY POLYMERS USA, LLC., Alpharetta, GA (US)

(72) Inventors: Thomas Burkhart, Dahn (DE); Rolf Walter, Kaiserslautern (DE); Hans-Peter Feldner, Gonbach (DE); Yuhong Wu, Alpharetta, GA (US); Geoffrey Scott Underwood, Atlanta, GA (US); Brian A. Stern, Duluth, GA (US)

(73) Assignee: SOLVAY SPECIALTY POLYMERS USA, LLC., Alpharetta, GA (US)

(21) Appl. No.: 14/401,344

(22) PCT Filed: May 16, 2013
(86) PCT No.: PCT/EP2013/060206

§ 371 Date: Nov. 14, 2014

Related U.S. Application Data
(60) Provisional application No. 61/647,637, filed on May 16, 2012.

(30) Foreign Application Priority Data
Sep. 5, 2012 (EP) 12183130.9

(51) Int. Cl. C08L 79/08; B29C 47/00; B29C 39/00; B29C 44/00; B29C 43/00; B29C 45/00; B29C 49/00

(52) U.S. Cl. CPC C08L 79/08; B29C 45/00; B29C 47/00; B29C 49/00; B29C 44/00; B29C 43/00; B29C 39/00; B29K 2079/08
USPC 524/406; 524/420; 524/408; 264/328.1; 264/176.1; 264/523; 264/41; 264/319; 264/299

(57) ABSTRACT

A resin composition [composition (C)] comprising: from 40 to 95% by volume (% v) of at least one aromatic polyimide [polymer (PI)], from 0.1 to 15% by volume (% v) of at least one compound having the general formula AₙXₘ [compound (AₙXₘ)], wherein each A is independently selected from a group consisting of a metal atom (M) which is selected from the group consisting of Fe, Co, Ni, Cu, Zn, Mo, Ag, Cd, Sn, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4, from 0.1 to 30% by volume (% v) of at least one carbon fiber, from 0 to 15% by volume (% v) of at least one filler selected from the group consisting of TiO₂, ZrO₂SiO₂ or mixtures thereof, and wherein all % are based on the total volume of the composition (C).

This application claims priority to U.S. provisional application No. 61/647,637 filed on 16 May 2012 and to European application 12183130.9 filed on 5 Sep. 2012, the whole content of each of these applications being incorporated herein by reference for all purposes.

### TECHNICAL FIELD

The present invention relates to an aromatic polyimide polymer, in particular an aromatic polyamide-imide polymer composition having improved tribological properties, to a process for its manufacture and to its use for the manufacture of tribological articles.

### BACKGROUND ART

Thermoplastics are increasingly displacing metals in many tribological materials such as radial and axial bearings, engines, gears, seals rings which are used in many automotive and industrial applications which require materials having the strength and wear resistance found in lubricated metals. Internally lubricated polymers are replacing metals in these applications because of their ease of fabrication, higher performance, lower or little dependence on external lubrication, and lower overall cost.

Considerable effort has already been directed towards developing improved tribological materials.

For example, US 2005/0096234 A (MACK, SR. ET AL.) May 5, 2005 describes plastic structures formed from a variety of plastic compositions which are formed from a variety of polymeric matrix materials such as notably polyamideimide (PAI), polyetherimide (PEI), polyimide (PI), polyetheretherketone (PEEK), polyphenylene sulphide (PPS), liquid crystal polymer (LCP), and combinations thereof and a variety of additives, described as first and second additives. The first additive is for example a graphitized pitch-based carbon fiber such as in particular Thermalgraph DKD or DKA (DKD or DKA fiber). The second additive includes notably tetrafluoroethylene (TFE), molybdenum disulfide, carbon, graphite, talc, and boron nitride.

U.S. Pat. No. 7,056,590 B (KS GLEITLAGER GMBH) Jun. 6, 2006 discloses a plain bearing composite material provided with a metallic support layer, optionally with a porous carrier layer applied thereto, and with a lead-free sliding layer, which forms a sliding partner and whose sliding layer material is based on plastic. The sliding layer material comprises PEEK as a matrix forming plastic constituent, a lubricant provided in the form of zinc sulfide, a hardening constituent provided in the form of titanium dioxide, and additionally comprises carbon fibers. The weight percentage proportion of the lubricant and of the hardening constituent with regard to the mass of the sliding layer material ranges from 5 to 15% by weight, and the lubricant and the hardening constituent are provided in the form of fine particles having a particle size D50-value of no greater than 500 nm.

It is known that a variety of materials may be added to polymeric matrix materials to provide or enhance their tribological properties. However, the selection of additives to improve tribological properties has been and continues to be difficult, as an additive that provides or enhances one desirable tribological property such as wear or Coefficient of Friction (COF) reduction, may degrade another desirable characteristic, such as reducing toughness or impact properties, reduction in tensile strength, reduction in tensile elongation, or reduction in fatigue properties.

For example, polyimides have been compounded with a variety of lubricants including graphite, molybdenum sulfide, bismuth nitride and the like to improve wear resistance under severe conditions. Compositions comprising polyimides and graphite, together with fluoropolymers, have found wide acceptance for use in a variety of applications requiring good friction and wear properties. However, the strength properties of these materials are also reduced when compounded with these additives at levels needed to attain the desired friction and wear characteristics.

Moreover, it is also known that the effect of the additive, such as for example the wear reduction of said additive, is specific to the polymer to which it is added.

There is thus a continuous need for new polymeric compositions based on new combinations of polymeric matrix materials and additives having improved tribological properties over a wide range of operating conditions while retaining all the critical properties of the polymeric matrix material such as high strength or toughness.

### BRIEF DESCRIPTION OF DRAWINGS

FIG. 1 illustrates the comparison of the wear rate (mm/h) of the tensile bars made from the composition of the example 5 measured at constant speed (10 m/s) and the pressure was varied from 4-14 MPa with the wear rate (mm/h) of the tensile bars made from the composition of comparative example C8 at constant speed (1 m/s) and the pressure varied from 0.5 to 4 MPa.

### SUMMARY OF INVENTION

The present invention thus relates to a resin composition [composition (C)] comprising:
from 40 to 95% by volume (% v) of at least one aromatic polyimide [polymer (PI)], based on the total volume of the composition (C);
from 0.1 to 15% by volume (% v) of at least one compound having the general formula AₙXₘ [compound (AₙXₘ)], wherein each A is independently selected from the group consisting of a metal atom (M) which is selected from the group consisting of Fe, Co, Ni, Cu, Zn, Mo, Ag, Cd, Sn, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4; based on the total volume of the composition (C);
from 0.1 to 30% by volume (% v) of at least one carbon fiber, based on the total volume of the composition (C);
from 0 to 15% by volume (% v) of at least one filler selected from the group consisting of TiO₂, ZrO₂ SiO₂ or mixtures thereof, based on the total volume of the composition (C).

Another specific object of the present invention is a resin composition [composition (C)] comprising:
from 40 to 95% by volume (% v) of at least one aromatic polyimide [polymer (PI)], based on the total volume of the composition (C);
from 0.1 to 15% by volume (% v) of at least one compound having the formula WS; based on the total volume of the composition (C);
from 0.1 to 30% by volume (% v) of at least one carbon fiber, based on the total volume of the composition (C);
from 0 to 15% by volume (% v) of at least one filler selected from the group consisting of TiO₂, ZrO₂ SiO₂ or mixtures thereof, based on the total volume of the composition (C).

The Applicant has found that the combination of the polymer (PI) with at least one compound (AₙXₘ), wherein each A is independently selected from a group consisting of a metal atom (M) which is selected from the group consisting of Fe, Co, Ni, Cu, Zn, Mo, Ag, Cd, Sn, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4 or at least one compound having the formula WS; with at least one carbon fiber and optionally with at least one filler, as mentioned above, provides compositions (C) having a dramatic and unexpected improvement in tribological properties such as wear resistance, low friction, low temperature generation and high limiting pressure and velocity (PV) values. In particular, the inventive composition (C) exhibits an exceptional decrease in speed sensitivity. Said compositions (C) further possess improved mechanical properties such as higher tensile modulus.

To the purpose of the present invention, the “aromatic polyimide [polymer (PI)]” is intended to denote any polymer comprising more than 50% moles of recurring units comprising at least one aromatic ring and at least one imide group, as such (formula 1A) or in its amic acid form (formula 1B) [recurring units (R_{PI})]:

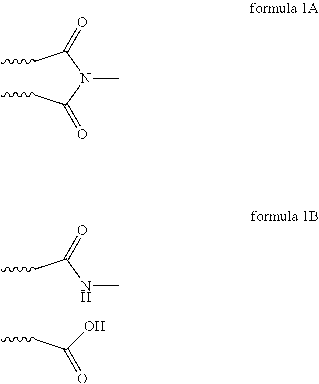

The imide group, as such or in its corresponding amic acid form, is advantageously linked to an aromatic ring, as illustrated below:

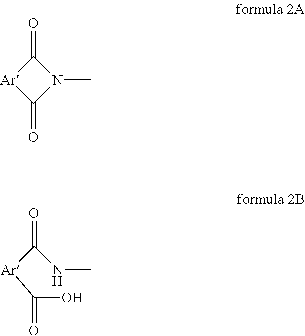

whereas Ar′ denotes a moiety containing at least one aromatic ring.

The imide group is advantageously present as condensed aromatic system, yielding a five- or six-membered heteroaromatic ring, such as, for instance, with benzene (phthalimide-type structure, formula 3) and naphthalene (naphthalimide-type structure, formula 4).

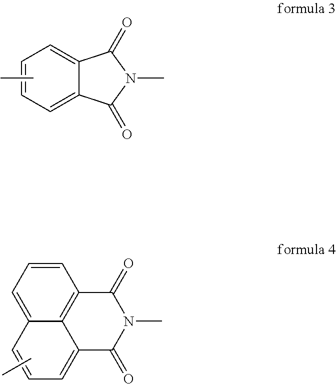

The formulae here below depict examples of recurring units (R_{PI}) (formulae 5A to 5C):

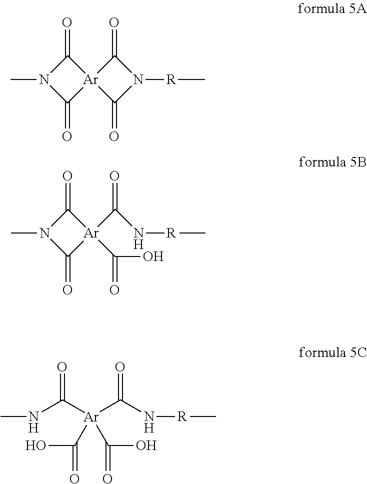

wherein:

Ar represents an aromatic tetravalent group; typically Ar is selected from the group consisting of following structures:

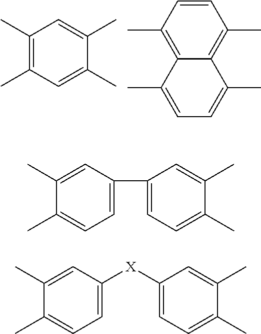

and corresponding optionally substituted structures, with X being —O—, —C(O)—, —CH₂—, —C(CF₃)₂—, —(CF₂)_{q}—, with q being an integer from 1 to 5;

R represents an aromatic divalent group; typically R is selected from the group consisting of following structures:

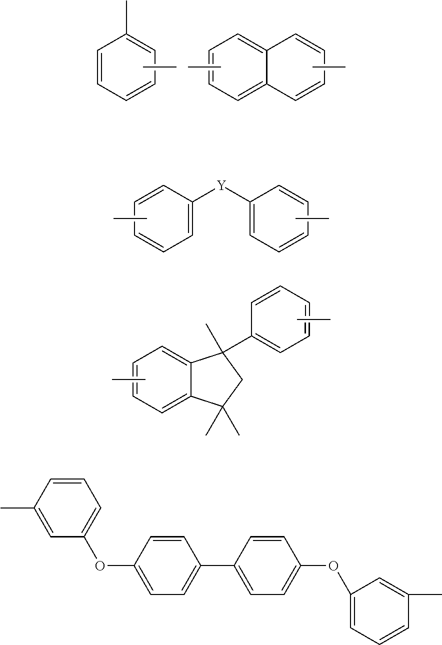

and corresponding optionally substituted structures, with Y being —O—, —S—, —SO₂—, —CH₂—, —C(O)—, —C(CF₃)₂—, —(CF₂)_{q}, q being an integer from 1 to 5.

Polyimides commercialized by DuPont as VESPEL® polyimides or by Mitsui as AURUM® polyimides are suitable for the purpose of the invention.

The recurring units (R_{PI}) of the polymer (PI) can comprise one or more functional groups other than the imide group, as such and/or in its amic acid form. Non limitative examples of polymers complying with this criterion are aromatic polyesterimides (PEI) and aromatic polyamide-imides (PAI).

In a specific embodiment of the present invention, the polymer (PI) is selected from the group consisting of an aromatic polyesterimides (PEI) and aromatic polyamide-imides polymer [polymer (PAI)].

To the purpose of the present invention, “aromatic polyesterimide” is intended to denote any polymer more than 50% moles of the recurring units comprise at least one aromatic ring, at least one imide group, as such and/or in its amic acid form, and at least one ester group [recurring units (R_{PEI})]. Typically, aromatic polyesterimides are made by reacting at least one acid monomer chosen from trimellitic anhydride and trimellitic anhydride monoacid halides with at least one diol, followed by reaction with at least one diamine.

For the purpose of the present invention, “aromatic polyamide-imide polymer [polymer (PAI)]” is intended to denote any polymer comprising more than 50% moles of recurring units comprising at least one aromatic ring, at least one imide group, as such and/or in its amic acid form, and at least one amide group which is not included in the amic acid form of an imide group [recurring units (R_{PAI})].

The recurring units (R_{PAI}) are advantageously chosen among those of formula:

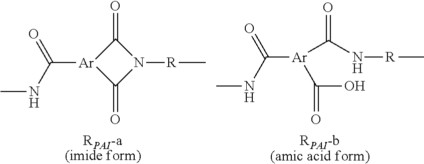

wherein:

Ar is a trivalent aromatic group; typically Ar is selected from the group consisting of following structures:

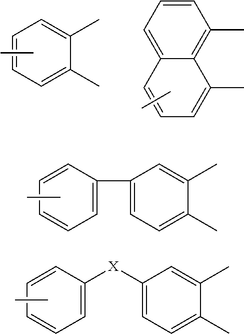

and corresponding optionally substituted structures, with X being —O—, —C(O)—, —CH₂—, —C(CH₃)₂—, —C(CF₃)₂—, —(CF₂)_{q}—, with q being an integer from 1 to 5;

R is a divalent aromatic group; typically R is selected from the group consisting of following structures:

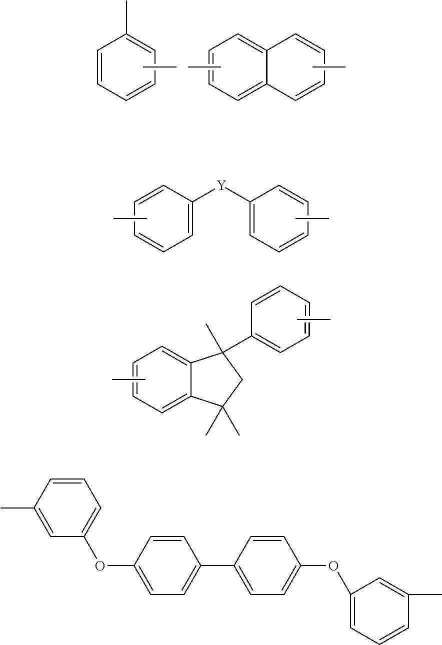

and corresponding optionally substituted structures, with Y being —O—, —S—, —SO₂—, —CH₂—, —C(O)—, —C(CH₃)₂—, —C(CF₃)₂—, —(CF₂)_{q}, q being an integer from 1 to 5.

Preferably, the aromatic polyamide-imide comprises more than 50% of recurring units (R_{PAI}) comprising an imide group in which the imide group is present as such, like in recurring units (R_{PAI}-a), and/or in its amic acid form, like in recurring units (R_{PAI}-b).

Recurring units (R_{PAI}) are preferably chosen from recurring units (l), (m) and (n), in their amide-imide (a) or amide-amic acid (b) forms:

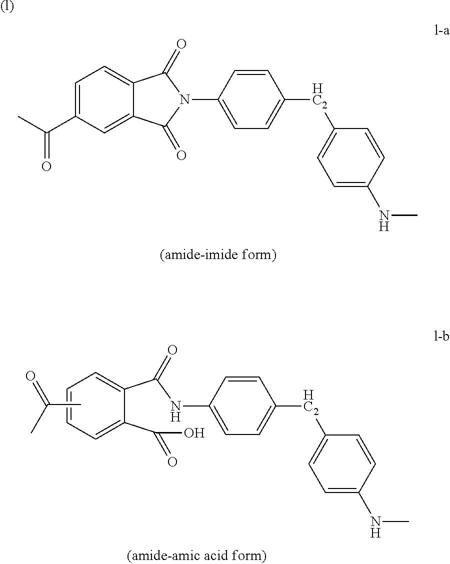

wherein the attachment of the two amide groups to the aromatic ring as shown in (l-b) will be understood to represent the 1,3 and the 1,4 polyamide-amic acid configurations;

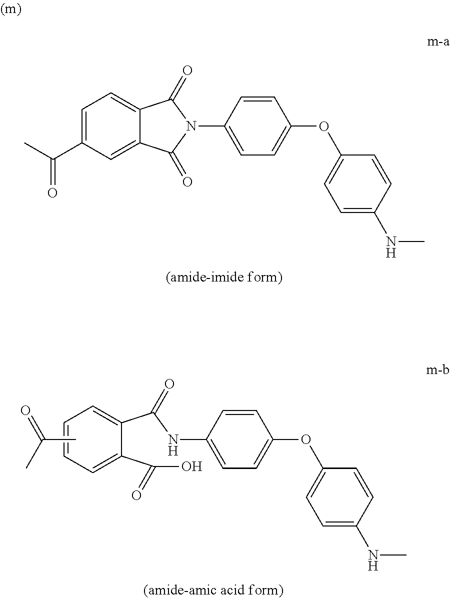

wherein the attachment of the two amide groups to the aromatic ring as shown in (m-b) will be understood to represent the 1,3 and the 1,4 polyamide-amic acid configurations; and

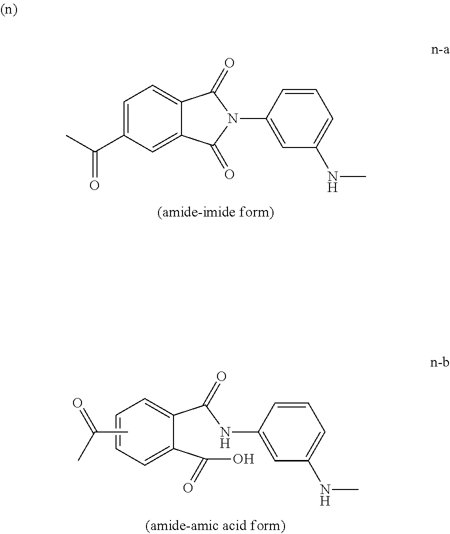

wherein the attachment of the two amide groups to the aromatic ring as shown in (n-b) will be understood to represent the 1,3 and the 1,4 polyamide-amic acid configurations.

More preferably, the polymer (PAI) comprises more than 90% moles of recurring units (R_{PAI}). Still more preferably, it contains no recurring unit other than recurring units (R_{PAI}). Polymers commercialized by Solvay Specialty Polymers USA, L.L.C. as TORLON® polyamide-imides comply with this criterion.

The total volume of the polymer (PI), based on the total volume of the composition (C), is advantageously above 50% v, preferably above 60% v; more preferably above 70% v, still more preferably above 80% v, more preferably above 90% v.

In a preferred embodiment, the total volume of the polymer (PAI), based on the total volume of the composition (C), is advantageously above 50% v, preferably above 60% v; still more preferably above 70% v, more preferably above 80% v, more preferably above 90% v.

Composition (C) comprises at least one compound (AₙXₘ), wherein each A is independently selected from the group consisting of a metal atom (M) which is selected from the group consisting of Fe, Co, Ni, Cu, Zn, Mo, Ag, Cd, Sn, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4. Within the context of the present invention the mention “at least one compound (AₙXₘ)” is intended to denote one or more than one compound (AₙXₘ). Mixtures of compounds (AₙXₘ) can also be used for the purposes of the invention.

In the compound (AₙXₘ), each A is independently selected from a group consisting of a metal atom (M) which is selected from the group consisting of Fe, Co, Ni, Cu, Zn, Mo, Ag, Cd, Sn, Pt, Au, Hg, Pb and Tl and an semimetal atom (SM) which is selected from the group consisting of As, Sb and Bi.

In a preferred embodiment, A is a metal atom (M), selected from the group consisting of Fe, Co, Ni, Cu, Zn, Mo, Ag, Cd, Sn, Pt, Au, Hg, Pb and Tl. Preferably, M is selected from the group consisting of Mo, Fe, Co, Ni, Cu, Ag and Zn and mixtures thereof. More preferably, M is Zn.

In another preferred embodiment, A is a metal atom (M), selected from the group consisting of Fe, Co, Fe, Co, Ni, Cu, Ag and Zn.

In the compound (AₙXₘ), each X is independently selected from a group consisting of As, Sb, S, Se and Te and it is understood that the nature of X and the number m of X are determined by the properties and valency of the atom A. The plurality of A's and X's, if any, may be the same or different.

Preferably, X is selected from the group consisting of S, Se and Te. More preferably, X is S.

Depending on the nature of X, the compound (AₙXₘ), as described above, can according to the Berzelian Classification or Strunz, as notably reported on the web site http://webmineral.com/strunz.shtml, incorporated herein by reference in its entirety, be classified as sulfides, antimonides, arsenides, selenides, tellurides and sulfosalts.

For the purpose of the present invention, when X is S and A is a metal atom (M), selected from the group consisting of Fe, Co, Ni, Cu, Zn, Mo, Ag, Cd, Sn, Pt, Au, Hg, Pb and Tl, then the compound (AₙXₘ) is classified as a metal sulfide.

For the purpose of the present invention, when X is S and A is a semimetal atom (SM) which is selected from the group consisting of As, Sb and Bi, then the compound (AₙXₘ) is classified as a semimetal sulfide.

For the purpose of the invention, when X is selected from the group of As, Sb, Se and Te, the minerals formed possess a chemical structure very similar to that of the sulfides. These are classified respectively as arsenides, antimonides, selenides, and tellurides.

For the purpose of the invention, when the compound (AₙXₘ) comprises at least one A which is a metal atom (M) selected from the group consisting of Fe, Co, Ni, Cu, Zn, Mo, Ag, Cd, Sn, Pt, Au, Hg, Pb and Tl and at least one A which is an semimetal atom (SM) selected from the group consisting of As and Sb; and X is S, then the compound (AₙXₘ) is classified as a sulfosalt.

Non limiting examples of metal sulfides are FeS₂, PbS, ZnS, CuFeS₂, CuS, HgS, Cu₂S and MoS₂. Most preferred metal sulfide is ZnS.

Non limiting examples of semimetal sulfides are AsS, As₂S₃ and Bi₂S₃.

Non limiting examples of sulfosalts are CoAsS, Ag₃SbS₃ and Ag₃AsS₃.

The composition (C) of the present invention advantageously comprises the compound (AₙXₘ) in an amount of at least 0.5% v, preferably at least 1.0% v, more preferably at least 2.0% v, based on the total volume of the composition (C).

The composition (C) of the present invention advantageously comprises the compound (AₙXₘ) in an amount of at most 12% v, preferably at most 8.0% v, more preferably at most 4% v, based on the total volume of the composition (C).

Compositions comprising the compound (AₙXₘ) in an amount of 1.0 to 4.0% v based on the total volume of the composition (C), gave particularly good results.

Compositions comprising the compound of formula WS in an amount of 1.0 to 4.0% v based on the total volume of the composition (C), gave particularly good results.

The above-mentioned compound (AₙXₘ) of the composition (C) is preferably present in the form of fine particles with a D50 particle size value of at most 400 nm, preferably of at most 300 nm. The D50 particle size value of the compound (AₙXₘ) of the composition (C) is preferably equal to or at least 100 nm, more preferably at least 200 nm. A D50 particle size value of compound (AₙXₘ) of the composition (C) of 300 nm gave particularly good results.

For the purpose of the present invention, the D50 value of the particle size means a particle size, such as 50 weight percent of the relevant material have a larger particle size and 50 weight percent have a smaller particle size.

The D50 value of the particle size of the compound (AₙXₘ) is measured using light scattering techniques (dynamic or laser) using the respective equipment coming for example from the company Malvern (Mastersizer Micro or 3000) or using screen analysis according to DIN 53196.

In a preferred embodiment of the present invention, the compound (AₙXₘ) is ZnS with a D50 particle size value from 200 to 400 nm.

Composition (C) further comprises at least one carbon fiber.

For the purpose of the present invention, the term “carbon fiber” is intended to include graphitized, partially graphitized and ungraphitized carbon reinforcing fibers or a mixture thereof.

For the purpose of the present invention, the term “fiber” means a fundamental form of solid (often crystalline) characterized by relative high tenacity and an extremely high ratio of length to diameter.

The term “graphitized” intends to denote carbon fibers obtained by high temperature pyrolysis (over 2000° C.) of carbon fibers, wherein the carbon atoms place in a way similar to the graphite structure.

Carbon fibers useful for the present invention can advantageously be obtained by heat treatment and pyrolysis of different polymer precursors such as, for example, rayon, polyacrylonitrile (PAN), aromatic polyamide or phenolic resin; carbon fibers useful for the present invention may also be obtained from pitchy materials.

Carbon fibers useful for the present invention are preferably chosen from the group composed of PAN-based carbon fibers (PAN-CF), pitch based carbon fibers, graphitized pitch-based carbon fibers, and mixtures thereof. More preferably, the carbon fibers are chosen from PAN-based carbon fibers and graphitized pitch-based carbon fibers. PAN-based carbon fibers (PAN-CF) are most preferred.

PAN-based carbon fibers (PAN-CF) have advantageously a diameter of between 5 to 20 μm, preferably from 7 to 15 μm, more preferably from 8 to 12 μm, most preferably from 6 to 8 μm. Good results were obtained with PAN-based carbon fibers (PAN-CF) having a diameter of 7 μm.

The PAN-CF maybe of any length. In general, the length of PAN-CF is at least 50 μm.

The PAN-CF has advantageously a length from 1 μm to 1 cm, preferably from 1 μm to 1 mm, more preferably from 5 μm to 500 μm and still more preferably from 50 to 150 μm.

The PAN-CF has advantageously a length to diameter ratio of at least 2, preferably of at least 5, more preferably of at least 7.

The PAN-CF has advantageously a length to diameter ratio of 2 to 30, preferably a ratio of 5 to 25, more preferably a ratio of 7 to 20. Good results were obtained with PAN-based carbon fibers (PAN-CF) having a ratio of 14 μm.

Graphitized pitch-based carbon fibers are readily available from commercial sources containing at least about 50% weight graphitic carbon, greater than about 75% weight graphitic carbon, and up to substantially 100% graphitic carbon. Highly graphitic carbon fiber particularly suitable for use in the practice of this invention may be further characterized as highly conductive, and such fiber is generally used having a modulus of about 80 to about 120 million pounds per square inch, i.e., million lbs/in² (MSI). In certain embodiments the highly graphitic carbon fiber has a modulus of about 85 to about 120 MSI, and in other certain embodiments about 100 to about 115 MSI.

The pitch-based-CF has advantageously a diameter between 5 to 20 μm, preferably from 7 to 15 μm, more preferably from 8 to 12 μm.

The pitch-based-CF maybe of any length. The pitch-based-CF has advantageously a length from 1 μm to 1 cm, preferably from 1 μm to 1 mm, more preferably from 5 μm to 500 μm and still more preferably from 10 to 20 μm.

The pitch-based-CF has advantageously a length to diameter ratio of at least 0.1, preferably of at least 3.0, more preferably of at least 10.0.

The pitch-based-CF has advantageously a length to diameter ratio of 0.1 to 30.0, preferably a ratio of 3 to 20, more preferably a ratio of 10 to 15.

Carbon fiber may be employed as chopped carbon fiber or in a particulate form such as may be obtained by milling or comminuting the fiber.

Comminuted graphitized pitch-based carbon fiber suitable for use in the practice of the invention may be obtained from commercial sources including from Cytec Carbon Fibers as ThermalGraph DKD X and CKD X grades of pitch-based carbon fiber and Mitsubishi Carbon Fibers as Dialead carbon fibers. Milled PAN-based carbon fibers preferably used in the present invention may be obtained from commercial sources.

The composition (C) of the present invention advantageously comprises the carbon fiber in an amount of at least 0.5% v, preferably at least 1.0% v, more preferably at least 5.0% v, based on the total volume of the composition (C).

The composition (C) of the present invention advantageously comprises the carbon fiber in an amount of at most 30% v, preferably at most 25% volume, more preferably at most 15% v, based on the total volume of the composition (C).

Compositions comprising the carbon fiber in an amount of 5 to 10% v, based on the total volume of the composition (C), gave particularly good results.

The composition (C) may optionally comprise a filler selected from the group consisting of TiO₂, ZrO₂ and SiO₂ or mixtures thereof.

For the purpose of the present invention, the term “filler” is intended to include surface treated, non-treated and core/shell structured fillers or a mixture thereof. The term “surface treated filler” intends to denote fillers obtained by notably heat treatment, chemical treatment by using for example silanes or phosphonate or plasma treatment of the surface of said filler. The term “core/shell structured filler” is intended to include fillers which are composed of a core selected from the group of consisting of TiO₂, ZrO₂ and SiO₂ or mixtures thereof, generally made up of between a few hundred and a few thousand atoms and surrounded by an organic outer layer of ionic or non-ionic surfactant molecules, such as notably silanes e.g. amino functionalized silanes or surrounded by an additional inorganic outer layer including notably metalloxide compounds.

When composition (C) comprises a filler, the filler is generally present in an amount of at most 15% v, preferably at most 10% v, more preferably at most 5% v, based on the total volume of the composition (C).

The composition (C) of the present invention advantageously comprises the filler in an amount of at least 0.1% v, preferably at least 0.5% volume, more preferably at least 1.0% v, most preferably at least 2.0% v, based on the total volume of the composition (C).

Compositions comprising the filler in an amount of 2% v, based on the total volume of the composition (C), gave particularly good results.

The filler is preferably TiO₂. The filler is more preferably surface treated TiO₂.

The above-mentioned filler of the composition (C) is preferably present in the form of fine particles with a D50 particle size value of at most 400 nm, preferably of at most 300 nm. The D50 particle size value of the filler of the composition (C) is preferably equal to or at least 100 nm, more preferably at least 200 nm. A D50 particle size value of the filler of the composition (C) of 300 nm gave particularly good results.

In a preferred embodiment of the present invention, the filler is TiO₂ with a D50 particle size value from 200 to 400 nm.

The D50 value of the particle size of the filler is measured via light scattering techniques (dynamic or laser) using the respective equipment coming for example from the company Malvern (Mastersizer Micro or 3000) or using screen analysis acc. to DIN 53196.

The composition (C) of the present invention can further comprise at least one additive (AD) selected from those known in the art to further improve the tribological properties of said composition (C). Non limiting examples of the additive (AD) includes in particular fluoropolymers known in the art for use as lubricants, graphite, mica and the like.

In general the amounts of such additional additives (AD) added to composition (C) are considered to be within the range of ordinary practice in the art.

Fluoropolymers suitable for use in the practice of this invention may be any of the fluoropolymers known in the art for use as lubricants, and preferably will be a polytetrafluoroethylene (PTFE). PTFE resins are widely known for chemical resistance and for lubricity and toughness, and PTFE powders have long been used to improve the lubricity of a wide variety of materials. PTFE spheres or beads may be incorporated in the polymeric composition to act as an internal lubricant and to create a smooth, slippery surface with enhanced friction and wear properties. Suitable fluoropolymer resins are readily available commercially from a variety of sources, including Zonyl® fluoroadditives from DuPont Company, Daikin-Polyflon™ PTFE from Daikin America Inc, Polymist® PTFE from Solvay Specialty Polymers SpA, and Polylube PA 5956 or TF9205 from Dyneon.

PTFE suitable for use in the practice of this invention has advantageously an average particle size from 0.1 to 40.0 μm, preferably from 1 to 30 μm, more preferably from 2 to 15 μm. Good results were obtained with an average particle size of 8 μm. The average particle size can be measured according to the ISO 13321 method.

When the composition (C) comprises PTFE, PFTE is generally present in an amount of at least 1% v, preferably at least 3% v, more preferably at least 5% v, most preferably 7% v, based on the total volume of the composition (C).

The composition (C) of the present invention advantageously comprises PFTE in an amount of at most 20% v, preferably at most 15% v, more preferably at most 10% v, based on the total volume of the composition (C).

Compositions comprising PTFE in an amount of 7 to 10% volume, based on the total volume of the composition (C), gave particularly good results.

Graphite suitable for use in the formulations according to the invention is generally spherical or flaky. The graphite should preferably be present as fine particles. The graphite should preferably be present as fine particles with advantageously a D50 particle size value of 1 to 30 μm, preferably of 8 to 25 μm, more preferably of 18 to 22 μm.

Generally, the composition (C) of the present invention comprises graphite in an amount of at least 1% v, preferably at least 3% v, more preferably at least 5% v, based on the total volume of the composition (C).

The composition (C) of the present invention advantageously comprises graphite in an amount of at most 20% v, preferably at most 15% v, more preferably at most 10% v, based on the total volume of the composition (C).

Compositions comprising graphite in an amount of 10% v, based on the total volume of the composition (C), gave particularly good results.

The addition of an inorganic, low hardness, thermally stable, sheet silicate, such as muscovite mica is disclosed in the art to produce dramatic improvement in the wear and friction characteristics of polyimide resins at when run at high pressures and at high surface speeds (high PV). If desired, adding from about 5 to about 20 pbv of such sheet silica additives, per hundred parts to the composition (C) may be found beneficial for providing materials intended to be used under such severe conditions.

Optionally, the composition (C) of the invention can further comprise one or more ingredients (I) such as for example, additives that improve certain of properties of the polymer composition, notably: short term mechanical capabilities (i.e. mechanical strength, toughness, hardness, stiffness), thermal conductivity, creep strength and fracture resistance, high temperature dimensional stability, fatigue resistance and the like. Non limiting examples of said other ingredients (I) may notably include glass fibers; glass beads; asbestos fibers; boron fibers (e.g. obtained by deposition of boron microgranules on a tungsten or carbonate yarn), metal fibers; ceramic fibers like silicon nitride Si₃N₄; talc-glass fibers; calcium silicate fibers like wollastonite micro-fibers; silicon carbide fibers; metal borides fibers (e.g. TiB₂) and mixtures thereof.

In one preferred embodiment, the composition (C) of the invention comprises:
from 40 to 95% by volume (% v) of at least one aromatic polyamide-imide polymer [polymer (PAI)], as described above, based on the total volume of the composition (C);
from 0.1 to 15% by volume (% v) of at least one compound having the general formula AₙXₘ [compound (AₙXₘ)], wherein each A is independently selected from the group consisting of a metal atom (M) which is selected from the group consisting of Fe, Co, Ni, Cu, Zn, Mo, Ag, Cd, Sn, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4; based on the total volume of the composition (C);
from 0.1 to 30% by volume (% v) of at least one carbon fiber, based on the total volume of the composition (C);
from 0.1 to 15% by volume (% v) of at least one filler selected from the group consisting of TiO₂, ZrO₂ SiO₂ or mixtures thereof, based on the total volume of the composition (C);
optionally, at least one additive (AD) selected from a group consisting of fluoropolymers, graphite and mica;
optionally, other ingredients (I).

In another preferred embodiment, the composition (C) of the invention comprises:
from 40 to 95% by volume (% v) of at least one aromatic polyamide-imide polymer [polymer (PAI)], as described above, based on the total volume of the composition (C);
from 0.1 to 15% by volume (% v) of at least one compound having the general formula AₙXₘ [compound (AₙXₘ)], wherein each A is independently selected from the group consisting of a metal atom (M) which is selected from the group consisting of Fe, Co, Ni, Cu, Zn, Ag, Cd, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4; based on the total volume of the composition (C);
from 0.1 to 30% by volume (% v) of at least one carbon fiber, based on the total volume of the composition (C);
from 0.1 to 15% by volume (% v) of at least one filler selected from the group consisting of TiO₂, ZrO₂ SiO₂ or mixtures thereof, based on the total volume of the composition (C);
optionally, at least one additive (AD) selected from a group consisting of fluoropolymers, graphite and mica;
optionally, other ingredients (I).

In another preferred embodiment, the composition (C) of the invention comprises:
from 40 to 95% by volume (% v) of at least one aromatic polyamide-imide polymer [polymer (PAI)], as described above, based on the total volume of the composition (C);
from 0.1 to 15% by volume (% v) of at least one compound having the general formula AₙXₘ [compound (AₙXₘ)], wherein each A is independently selected from the group consisting of a metal atom (M) which is selected from the group consisting of Fe, Co, Ni, Cu, Zn, Mo, Ag, Cd, Sn, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4; based on the total volume of the composition (C);
from 0.1 to 30% by volume (% v) of at least one carbon fiber, based on the total volume of the composition (C);
from 0.1 to 15% by volume (% v) of at least one filler selected from the group consisting of TiO₂, ZrO₂ SiO₂ or mixtures thereof, based on the total volume of the composition (C);
from 1 to 20% by volume (% v) of PTFE, based on the total volume of the composition (C); and
from 1 to 20% by volume (% v) of graphite, based on the total volume of the composition (C).

In another preferred embodiment, the composition (C) of the invention comprises:
from 40 to 95% by volume (% v) of at least one aromatic polyamide-imide polymer [polymer (PAI)], as described above, based on the total volume of the composition (C);
from 0.1 to 15% by volume (% v) of at least one compound having the general formula AₙXₘ [compound (AₙXₘ)], wherein each A is independently selected from the group consisting of a metal atom (M) which is selected from the group consisting of Fe, Co, Ni, Cu, Zn, Ag, Cd, Pt, Au, Hg, Pb and Tl and a semimetal atom (SM) which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4; based on the total volume of the composition (C);
from 0.1 to 30% by volume (% v) of at least one carbon fiber, based on the total volume of the composition (C);
from 0.1 to 15% by volume (% v) of at least one filler selected from the group consisting of TiO₂, ZrO₂ SiO₂ or mixtures thereof, based on the total volume of the composition (C);
from 1 to 20% by volume (% v) of PTFE, based on the total volume of the composition (C); and
from 1 to 20% by volume (% v) of graphite, based on the total volume of the composition (C).

In yet another preferred embodiment, the composition (C) of the invention comprises:
from 40 to 95% by volume (% v) of at least one aromatic polyamide-imide polymer [polymer (PAI)], as described above, based on the total volume of the composition (C);
from 0.1 to 15% by volume (% v) of ZnS, based on the total volume of the composition (C);
from 0.1 to 30% by volume (% v) of PAN-based carbon fibers (PAN-CF), based on the total volume of the composition (C);
from 0.1 to 15% by volume (% v) of TiO₂, based on the total volume of the composition (C);
from 1 to 20% by volume (% v) of PTFE, based on the total volume of the composition (C); and
from 1 to 20% by volume (% v) of graphite, based on the total volume of the composition (C).

In yet another preferred embodiment, the composition (C) of the invention comprises:
from 40 to 95% by volume (% v) of at least one aromatic polyamide-imide polymer [polymer (PAI)], as described above, based on the total volume of the composition (C);
from 0.1 to 15% by volume (% v) of at least one compound having the formula WS, based on the total volume of the composition (C);
from 0.1 to 30% by volume (% v) of PAN-based carbon fibers (PAN-CF), based on the total volume of the composition (C);
from 0.1 to 15% by volume (% v) of TiO₂, based on the total volume of the composition (C);
from 1 to 20% by volume (% v) of PTFE, based on the total volume of the composition (C); and
from 1 to 20% by volume (% v) of graphite, based on the total volume of the composition (C).

Another aspect of the present invention concerns a process for manufacturing the polymer composition (C) as above described, which comprises mixing:
at least one aromatic polyimide polymer [polymer (PI)], as detailed above;
at least one compound (AₙXₘ), as detailed above;
at least one carbon fiber, as detailed above; and
optionally, at least one filler, as detailed above.

Another aspect of the present invention concerns a process for manufacturing the polymer composition (C) as above described, which comprises mixing:
at least one aromatic polyimide polymer [polymer (PI)], as detailed above;
at least one compound having the formula WS;
at least one carbon fiber, as detailed above; and
optionally, at least one filler, as detailed above.

In a preferred embodiment, the process of the invention comprises mixing at least one aromatic polyimide polymer [polymer (PI)], as detailed above; at least one compound (AₙXₘ), as detailed above; at least one carbon fiber, as detailed above; and at least one filler and optionally, other additives (AD), in particular PTFE, as described above and graphite particles, as described above and other ingredients (I).

In a more preferred embodiment, the process of the invention comprises mixing at least one aromatic polyamide-imide polymer [polymer (PAI)], as detailed above; at least one compound (AₙXₘ), as detailed above; at least one carbon fiber, as detailed above; and at least one filler and optionally, other additives (AD), in particular PTFE, as described above and graphite particles, as described above and other ingredients.

Advantageously, the process of the invention comprises mixing by dry blending and/or melt compounding the polymer (PI), in particular the polymer (PAI), the compound (AₙXₘ), the carbon fiber and optionally, the filler, other additives (AD) and other ingredients (I).

Preferably, the polymer (PAI), the compound (AₙXₘ), the carbon fiber, and optionally, the filler, other additives (AD) and other ingredients (I) are mixed by melt compounding.

Advantageously, the polymer (PI), in particular the polymer (PAI), the compound (AₙXₘ), the carbon fiber and optionally, the filler, other additives (AD) and other ingredients (I) are melt compounded in continuous or batch devices. Such devices are well-known to those skilled in the art.

In a particular preferred embodiment, the polymer (PAI), the compound (AₙXₘ), the carbon fiber, the filler, PTFE and graphite particles are mixed by melt compounding in continuous or batch devices.

In another particular preferred embodiment, the polymer (PAI), the compound having the formula WS, the carbon fiber, the filler, PTFE and graphite particles are mixed by melt compounding in continuous or batch devices.

Examples of suitable continuous devices to melt compound the polymer composition of the invention are notably screw extruders. Thus, the polymer (PI), in particular the polymer (PAI), the compound (AₙXₘ), the carbon fiber, the filler, PTFE and graphite particles, are advantageously fed in powder or granular form in an extruder and the composition is extruded into strands and the strands are chopped into pellets.

In a most preferred embodiment, the polymer (PAI), the compound (AₙXₘ), the carbon fiber, the filler, PTFE and graphite particles are melt compounded in a twin-screw extruder.

In another most preferred embodiment, the polymer (PAI), the compound having the formula WS, the carbon fiber, the filler, PTFE and graphite particles are melt compounded in a twin-screw extruder.

The composition (C) can be further processed following standard methods for injection moulding, extrusion, blow moulding, foam processing, compression molding, casting, coating and the like. Finished articles comprising the composition (C) as described above can undergo post-fabrication operations such as post-curing.

Another object of the invention is an article comprising the composition (C) as described above.

The total weight of the composition (C), based on the total weight of the article, is advantageously above 50%, preferably above 80%; more preferably above 90%; more preferably above 95% and more preferably above 99%. If desired, the article may consist of the composition (C).

Advantageously, the article is an injection moulded article, an extrusion moulded article, a shaped article, a coated article or a casted article.

Non limiting examples of articles include notably bearing articles such as radial and axial bearings for auto transmission, bearings used in dampers, shock absorbers, bearings in any kind of pumps e.g. acid pumps, hydraulically actuated seal rings for clutch components.

In a particular embodiment, the article is a bearing article.

For the purpose of the present invention, the term “bearing article” refers to articles with a bearing surface that are subjected to relatively high loads, relatively high speeds, or both. “Bearing articles” and “bearings,” as used herein, refers to any article(s) having a surface that interacts with a surface in relative motion, for example, by sliding, pivoting, oscillating, reciprocating, rotating, or the like. Examples of such articles include, but are not limited to, thrust bearings, sleeve bearings, journal bearings, thrust washers, rub strips, bearing pads, needle bearings, ball bearings, including the balls, valve seats, piston rings, valve guides, compressor vanes, and seals, under dynamic conditions.

The bearing article can notably consist of several parts, wherein at least one of said parts, and possibly all of them, consist of the composition (C). When at least one part of a multi-part bearing article consists of a material other than the polymer composition (e.g. metal or steel) [hereinafter, the other part], the weight of said other part, based on the weight of the bearing article, is usually less than 90%, and is often less than 50%, or even less than 10%. In accordance with the present invention, a certain preferred bearing article is a single part consisting of the composition (C). Another preferred bearing article consists of several parts consisting of the composition (C).

All definitions and preferences provided in respect of the inventive composition (C) apply to the process for preparing the composition (C), to the process for preparing an article comprising the composition (C) as well as to the article itself.

The Applicant has found unexpectedly that the composition (C) of the present invention is effective in providing articles having improved wear resistance and low friction under very severe conditions such as notably extreme dry sliding conditions over prior art articles.

Should the disclosure of any patents, patent applications, and publications which are incorporated herein by reference conflict with the description of the present application to the extent that it may render a term unclear, the present description shall take precedence.

The invention will now be described in more details with reference to the following examples, whose purpose is merely illustrative and not intended to limit the scope of the invention.

### Raw Materials

Torlon® 4000T is an aromatic polyamide-imide polymer commercially available from Solvay Specialty Polymers USA, LLC.

ZnS: Obtained as Sachtolith HDS from Sachtleben Chemie GmbH, D50 particle size of 300 nm.
TiO₂: Obtained as Kronos® 2320, D50 particle size of 300 nm.
PTFE: Polytetrafluoroethylene powdered resin, obtained as TF9205 PTFE micropowder from 3M™ Dyneon™, average particle size is 8 μm.
Carbon fiber: PAN-CF; Milled, obtained as Toho Tenax® A383 from TOHO TENAX Company, length 50-150 μm.
Graphite: Obtained as Graphite RGC39A grade from Superior Graphite Company, the D50 particle size is 20 μm.

### General Description of the Compounding Process of the Aromatic Polyamide-Imide Polymer Compositions

A dry blend of PAI polymers with the desired amounts of PTFE, and graphite was first prepared by tumble blending. The preblended mixture was then fed into the main hopper (barrel 1) of a Berstorff 25 mm twin screw extruder. The desired amounts of ZnS, WS or BiS, respectively TiO₂ and carbon fiber were fed gravimetric ally into sidefeeder 1, respectively 2 (fixed at barrel 4 and 6). The extruder had an L/D ratio of 44 and a total of 9 barrel sections and a vacuum vent located at barrel section 8. The extrudate was cut into pellets for molding.

The thus obtained pellets of the polymer compositions were next dried for 12 hours in a desiccated air oven at 120° C. and were then injection molded into rectangular bars (4×4 mm) for tribological tests. The molded rectangular bars were thermally cured for 17 days after molding.

Composition of the different polymer compositions are summarized in table 1.

TABLE 1

| | Examples N° | | | | | | | | | | |
|---|---|---|---|---|---|---|---|---|---|---|---|
| Polymer | | | | | | | | | | | Reference |
| composition | C1 | 2 | 3 | C4 | 5 | 6 | C7 | C8 | 9 | 10 | 1 |
| PAI (% v) | 77 | 72 | 67 | 71 | 69 | 71 | 73 | 25 | 69 | 69 | 75 |
| ZnS (% v) | 4 | 4 | 4 | 0 | 4 | 2 | 0 | 10 | | | 0 |
| WS (% v) | | | | | | | | | 4 | | |
| BiS (% v) | | | | | | | | | | 4 | |
| TiO₂ (% v) | 2 | 2 | 2 | 2 | 2 | 2 | 2 | 10 | 2 | 2 | 0 |
| PTFE (% v) | 7 | 7 | 7 | 7 | 10 | 10 | 10 | — | 10 | 10 | 7 |
| Graphite | 10 | 10 | 10 | 10 | 10 | 10 | 10 | 15 | 10 | 10 | 18 |
| (% v) | | | | | | | | | | | |
| Carbon fiber | 0 | 5 | 10 | 10 | 5 | 5 | 5 | 40 | 5 | 5 | 0 |
| (% v) | | | | | | | | | | | |
| Pan-CF | | | | | | | | | | | |

Reference 1 represents the commercial Torlon® 4630 grade available from Solvay Specialty Polymers USA, LLC, without ZnS; TiO₂ and Carbon Fiber, in particular Pan-CF.

The extrusion conditions are summarized in table 2.

TABLE 2
Screw Diameter: 25 mm
Screw Speed: 200 rpm L/D = 44

| Zone | Name | T_{Barrel} [° C.] |
|---|---|---|
| 1 | Main Hopper | 60 |
| 2 | | 230 |
| 3 | | 245 |
| 4 | Sidefeeder 1 | 270 |
| 5 | | 290 |
| 6 | Sidefeeder 2 | 295 |
| 7 | | 315 |
| 8 | Vacuum | 320 |
| 9 | | 315 |
| 10 | Die plate | 330 |

### Tribological Tests

Tribological tests were performed according to DIN 31680 by using a pin-on-disc apparatus, incorporated herein by reference in its entirety. The testing was carried out at ambient temperature and the respective wear rates as well as coefficient of friction were measured on-line. The tribological runs were performed statically as well as dynamically. In case of dynamic runs the speed or pressure were changed every 5 hours.

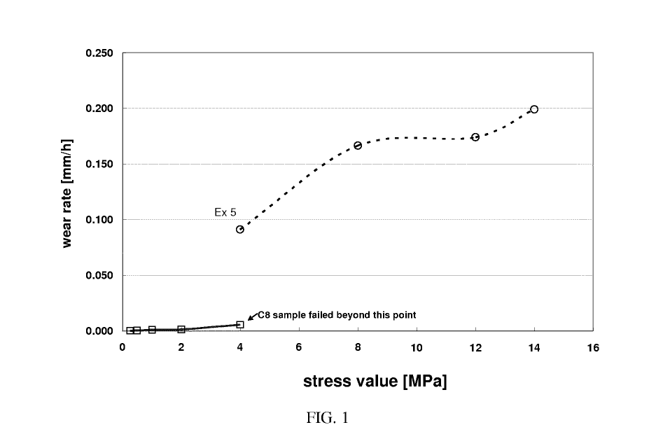

The tribological testing involved the study of linear wear rate, the coefficient of friction, the temperature generation and the limiting pressure and velocity (PV-limit) values of the rectangular bars, as described above. The tribological properties are summarized in tables 3 to 8 and FIG. 1.

For the purpose of the present invention, the term “wear” refers to the amount of the polymer composition removed from the rectangular bar surface as a result of the relative motion of the rectangular bar surface against a surface with which the rectangular bar surface interacts.

The linear wear rate and coefficient of friction (COF, μ[1]) were determined following the existing DIN 31680 standard test method. The wear rate is expressed in mm/h.

The load and velocity bearing capability of the polymer composition may be expressed as that combination of load and speed at which the coefficient of friction or the temperature of a bearing surface fails to stabilize. As used herein, the term “PV limit” will be used to denote the pressure-velocity relationship determined by the combination of load and speed at which the coefficient of friction or the temperature of the tensile bar surface fails to stabilize, expressed by the product of the unit pressure P (in MPa) based upon the contact area and the linear velocity V or speed (in m/s).

The data in table 3 below shows the wear rate (mm/h) and the coefficient of friction (COF, μ) of the rectangular bars made from the compositions of the examples of the present invention, namely 2 and 3, measured at constant pressure (2 MPa) and the speed was varied from 2-10 m/s. Their behaviour was compared to that of the comparative samples C1 and C4, the reference 1, commercial Torlon® 4630 grade and a reference 2 commercial PEEK composition, namely TECACOMP® PEEK-PVX (obtained from Ensinger Compounds).

TABLE 3

| | | C1 | | 2 | | 3 | | C4 | | Reference 1 | | Reference 2 | |
|---|---|---|---|---|---|---|---|---|---|---|---|---|---|
| speed | PV-product | Wear rate | COF | Wear rate | COF | Wear rate | COF | Wear rate | COF | Wear rate | COF | Wear rate | COF |
| (m/s) | (MPa × m/s) | mm/h | μ [1] | mm/h | μ [1] | mm/h | μ [1] | mm/h | μ [1] | mm/h | μ [1] | mm/h | μ [1] |
| 2 | 4 | 0.007 | 0.35 | 0.010 | 0.460 | 0.011 | 0.475 | 0.016 | 0.41 | — | — | — | — |
| 4 | 8 | 0.003 | 0.30 | 0.023 | 0.230 | 0.020 | 0.195 | 0.043 | 0.27 | 0.011 | 0.31 | 0.033 | 0.34 |
| 6 | 12 | 0.022 | 0.30 | 0.024 | 0.174 | 0.027 | 0.161 | 0.052 | 0.21 | 0.047 | 0.26 | 0.064 | 0.25 |
| 8 | 16 | 0.424 | 0.28 | 0.034 | 0.145 | 0.034 | 0.139 | 0.051 | 0.19 | 0.264 | 0.19 | 0.076 | 0.18 |
| 10 | 20 | 0.933 | 0.28 | 0.044 | 0.126 | 0.044 | 0.122 | 0.070 | 0.18 | — | — | — | — |

Reference 1 represents the commercial Torlon® 4630 grade available from Solvay Specialty Polymers USA, LLC, without ZnS; TiO₂ and Carbon Fiber. Reference 2 represents commercial PEEK composition, namely TECACOMP® PEEK-PVX (obtained from Ensinger Compounds). (formulation contains 10/10/10 CF/PTFE/Graphite).

These data clearly shows the effect of the ZnS and Carbon fiber thereby showing in particular a decreased sensitivity to speed.

The data in table 4 below shows the wear rate (mm/h), the generated temperature and coefficient of friction (COF, μ) of the tensile bars made from the compositions of the examples of the present invention, namely 2 and 3, measured at constant speed (2 m/s) and the pressure was varied from 4-14 MPa. Their behaviour was compared to that of the comparative samples C1 and C4, the reference 1, commercial Torlon® 4630 grade and a reference 2 commercial PEEK composition, namely TECACOMP® PEEK-PVX (obtained from Ensinger Compounds).

TABLE 4

| Pres- | | C1 | | 2 | | 3 | | C4 | | Reference 1 | | Reference 2 | |
|---|---|---|---|---|---|---|---|---|---|---|---|---|---|
| sure (P) | PV-product | Wear rate | COF | Wear rate | COF | Wear rate | COF | Wear rate | COF | Wear rate | COF | Wear rate | COF |
| (MPa) | (MPa × m/s) | mm/h | μ [1] | mm/h | μ [1] | mm/h | μ [1] | mm/h | μ [1] | mm/h | μ [1] | mm/h | μ [1] |
| 4 | 8 | 0.012 | 0.33 | 0.021 | 0.37 | 0.029 | 0.25 | 0.094 | 0.25 | 0.015 | 0.29 | 0.049 | 0.41 |
| 8 | 16 | 0.032 | 0.19 | 0.030 | 0.12 | 0.029 | 0.14 | 0.077 | 0.16 | 0.027 | 0.17 | 0.055 | 0.19 |
| 12 | 24 | 0.037 | 0.13 | 0.030 | 0.09 | 0.033 | 0.12 | 0.048 | 0.11 | 0.046 | 0.14 | 0.055 | 0.15 |
| 14 | 28 | 0.037 | 0.11 | 0.042 | 0.09 | 0.044 | 0.12 | 0.055 | 0.11 | 0.046 | 0.12 | — | — |

Reference 1 represents the commercial Torlon® 4630 grade available from Solvay Specialty Polymers USA, LLC, without ZnS; TiO₂ and Carbon Fiber. Reference 2 represents commercial PEEK composition, namely TECACOMP® PEEK-PVX (obtained from Ensinger Compounds).

The data in table 5 below shows the wear rate (mm/h) and the coefficient of friction (COF, μ) of the tensile bars made from the compositions of the examples of the present invention, namely 5 and 6, measured at constant pressure (14 MPa) and the speed was varied from 2-10 m/s. Their behaviour was compared to that of the comparative sample C7 and the reference 1, the commercial Torlon® 4630 grade.

TABLE 5

| | | Example N° | | | | | | | |
|---|---|---|---|---|---|---|---|---|---|
| | | 5 | | 6 | | C7 | | Reference 1 | |
| | PV- | Wear | | Wear | | Wear | | Wear | |
| Speed | prod- | rate | COF | rate | COF | rate | COF | rate | COF |
| (m/s) | uct | mm/h | μ [1] | mm/h | μ [1] | mm/h | μ [1] | mm/h | μ [1] |
| 2 | 28 | 0.038 | 0.104 | 0.045 | 0.101 | 0.083 | 0.108 | 0.030 | 0.140 |
| 4 | 56 | 0.070 | 0.066 | 0.066 | 0.065 | 0.077 | 0.082 | 0.080 | 0.130 |
| 8 | 112 | 0.129 | 0.058 | 0.133 | 0.067 | 0.419 | 0.065 | >3 | 0.160 |
| 10 | 140 | 0.172 | 0.058 | 0.186 | 0.075 | 0.827 | 0.067 | | |

Reference 1 represents the commercial Torlon® 4630 grade available from Solvay Specialty Polymers USA, LLC, without ZnS; TiO₂ and Carbon Fiber.

The data in table 6 below shows the wear rate (mm/h) and the coefficient of friction (COF, μ[1]) of the tensile bars made from the compositions of the examples of the present invention, namely 5 and 6, measured at constant speed (10 m/s) and the pressure was varied from 4-14 MPa. Their behaviour was compared to that of the comparative sample C7 and the reference 1, commercial Torlon® 4630 grade.

TABLE 6

| | | Example N° | | | | | | | |
|---|---|---|---|---|---|---|---|---|---|
| | | 5 | | 6 | | C7 | | Reference 1 | |
| Pressure | PV- | Wear | | Wear | | Wear | | Wear | |
| (P) | prod- | rate | COF | rate | COF | rate | COF | rate | COF |
| (MPa) | uct | mm/h | μ [1] | mm/h | μ [1] | mm/h | μ [1] | mm/h | μ [1] |
| 4 | 40 | 0.091 | 0.088 | 0.094 | 0.077 | 0.151 | 0.125 | 0.154 | 0.160 |
| 8 | 80 | 0.166 | 0.116 | 0.152 | 0.097 | 0.258 | 0.087 | 2.480 | 0.120 |
| 12 | 120 | 0.174 | 0.084 | 0.180 | 0.087 | 0.284 | 0.068 | | |
| 14 | 140 | 0.199 | 0.071 | 0.187 | 0.071 | | | | |

Reference 1 represents the commercial Torlon® 4630 grade available from Solvay Specialty Polymers USA, LLC, without ZnS; TiO₂ and Carbon Fiber.

The data in table 7 below shows the wear rate (mm/h) and the coefficient of friction (COF, μ) of the tensile bars made from the compositions of the examples of the present invention, namely 5, 9 and 10, measured at constant pressure (14 MPa) and the speed was varied from 2-10 m/s. Their behaviour was compared to that of reference 1, commercial Torlon® 4630 grade.

TABLE 7

| | | Example N° | | | | | | | |
|---|---|---|---|---|---|---|---|---|---|
| | | 5 | | 9 | | 10 | | Reference 1 | |
| | | Wear | | Wear | | Wear | | Wear | |
| speed | PV- | rate | COF | rate | COF | rate | COF | rate | COF |
| (m/s) | product | mm/h | μ [1] | mm/h | μ [1] | mm/h | μ [1] | mm/h | μ [1] |
| 2 | 28 | 0.038 | 0.104 | 0.074 | 0.090 | 0.081 | 0.110 | 0.030 | 0.140 |
| 4 | 56 | 0.070 | 0.066 | 0.079 | 0.060 | 0.123 | 0.090 | 0.080 | 0.130 |
| 8 | 112 | 0.129 | 0.058 | 0.132 | 0.040 | 0.193 | 0.070 | >3 | 0.160 |
| 10 | 140 | 0.172 | 0.058 | 0.219 | 0.060 | 0.562 | 0.080 | | |

Reference 1 represents the commercial Torlon® 4630 grade available from Solvay Specialty Polymers USA, LLC, without ZnS; TiO₂ and Carbon Fiber.

The data in table 8 below shows the wear rate (mm/h) and the coefficient of friction (COF, μ[1]) of the tensile bars made from the compositions of the examples of the present invention, namely 5, 9 and 10, measured at constant speed (10 m/s) and the pressure was varied from 4-14 MPa. Their behaviour was compared to that of reference 1, commercial Torlon® 4630 grade.

TABLE 8

| | | Example N° | | | | | | | |
|---|---|---|---|---|---|---|---|---|---|
| | | 5 | | 9 | | 10 | | | |
| Pressure | PV- | Wear | | Wear | | Wear | | Reference 1 | |
| (P) | prod- | rate | COF | rate | COF | rate | COF | Wear | |
| (MPa) | uct | mm/h | μ [1] | mm/h | μ [1] | mm/h | μ [1] | rate | COF |
| 4 | 40 | 0.091 | 0.088 | 0.100 | 0.110 | 0.189 | 0.200 | 0.154 | 0.160 |
| 8 | 80 | 0.166 | 0.116 | 0.167 | 0.080 | 0.258 | 0.110 | 2.480 | 0.120 |
| 12 | 120 | 0.174 | 0.084 | 0.192 | 0.060 | 0.275 | 0.070 | — | — |
| 14 | 140 | 0.199 | 0.071 | 0.207 | 0.060 | — | — | — | — |

Reference 1 represents the commercial Torlon® 4630 grade available from Solvay Specialty Polymers USA, LLC, without ZnS; TiO₂ and Carbon Fiber.

For comparative example C8, the wear rate (mm/h) and the coefficient of friction (COF, μ) of the rectangular bars were measured at much lower PV-product (MPa×m/s), in particular ranging from 0.5 to 8, due to deformation of the rectangular bar and failure of the pin occurring when PV-product (MPa×m/s) is 4 by applying a speed of 1 m/s and a pressure of 4 MPa, as shown in FIG. 11.

1. A resin composition, comprising
from 40 to 95% by volume (% v) of at least one aromatic polyimide,
from 0.1 to 15% by volume (% v) of:
at least one compound having the general formula AₙXₘ, wherein each A is independently selected from the group consisting of a metal atom which is selected from the group consisting of Fe, Co, Ni, Cu, Zn, Ag, Cd, Pt, Au, Hg, Pb and Tl and a semimetal atom which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4, or
at least one compound having the formula WS,
from 0.1 to 30% by volume (% v) of at least one carbon fiber,
from 0.1 to 15% by volume (% v) of at least one filler selected from the group consisting of TiO₂, ZrO₂ SiO₂ or mixtures thereof,
and wherein all % are based on the total volume of the composition.

2. The resin composition of claim 1, wherein the composition comprises
from 0.1 to 15% by volume (% v) of the at least one compound having the formula WS.

3. The composition according to claim 1, wherein the aromatic polyimide comprises more than 50% moles of recurring units comprising at least one aromatic ring and at least one imide group, in its imide form, according to (formula 1A)—or in its amic acid form, according to (formula 1B)

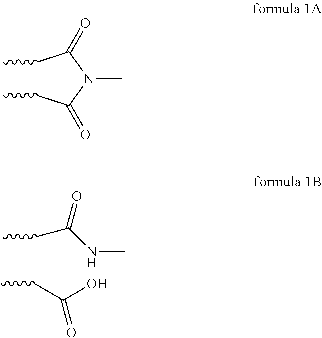

4. The composition according to claim 3, wherein the aromatic polyimide is an aromatic polyamide-imide polymer comprising more than 50% moles of recurring units comprising at least one aromatic ring, at least one imide group, as such and/or in its amic acid form, and at least one amide group which is not included in the amic acid form of an imide group, said recurring units being selected from the group consisting of: 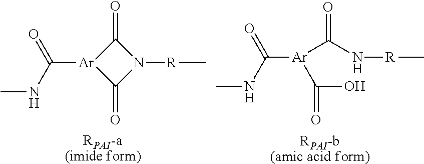
wherein:
Ar is a trivalent aromatic group; and
R is a divalent aromatic group.

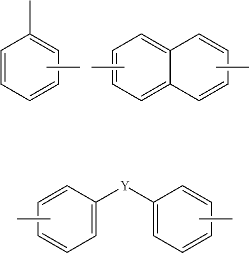

5. The composition according to claim 1, wherein AₙXₘ is a metal sulfide wherein X is S and A is a metal atom selected from the group consisting of Fe, Co, Ni, Cu, Zn, Ag, Cd, Pt, Au, Hg, Pb and Tl.

6. The composition according to claim 1, wherein AₙXₘ is a semimetal sulfide wherein X is S and A is a semimetal atom which is selected from the group consisting of As, Sb and Bi.

7. The composition according to claim 1, wherein the carbon fiber is selected from the group composed of PAN-based carbon fibers (PAN-CF), pitch based carbon fibers, graphitized pitch-based carbon fibers, and mixtures thereof.

8. The composition according to claim 7, wherein the carbon fiber is a PAN-based carbon fiber having a length to diameter ratio of at least 2.

9. The composition according to claim 1, wherein the filler is TiO₂.

10. The composition according to claim 1, wherein the composition further comprises at least one additive selected from a group consisting of a fluoropolymer, mica and graphite and said additive is present in an amount of 1% v-20% v, based on the total volume of the composition.

11. A process for manufacturing the polymer composition according to claim 1, which comprises mixing:
at least one aromatic polyimide
at least one compound having the general formula AₙXₘ, wherein each A is independently selected from a group consisting of a metal atom which is selected from the group consisting of Fe, Co, Ni, Cu, Zn, Ag, Cd, Pt, Au, Hg, Pb and Tl and a semimetal atom which is selected from the group consisting of As, Sb and Bi; wherein each X is independently selected from a group consisting of As, Sb, S, Se and Te; with the proviso that when A is As or Sb then X is different from A; and wherein n and m equal or different from each other, are independently 1, 2, 3 and 4; or at least one compound having the formula WS,
at least one carbon fiber,
at least one filler selected from the group consisting of TiO₂, ZrO₂, SiO₂ or mixtures thereof, and
optionally, at least one additive.

12. The process according to claim 11, wherein the, aromatic polyimide, AₙXₘ, the carbon fiber and the filler, and the additives are melt compounded in continuous or batch devices are mixed by melt compounding.

13. An article comprising the composition according to claim 1.

14. The article according to claim 13, wherein the article is a bearing article.

15. A process for the manufacturing of an article, comprising injection moulding, extrusion, blow moulding, foam processing, compression molding, casting and coating of the composition according to claim 1.

16. The composition of claim 1, wherein the composition comprises from 0.1 to 15% by volume (% v) of at the least one compound having the general formula AₙXₘ.

17. The composition according to claim 4, wherein
Ar is selected from the group consisting of the following structures: 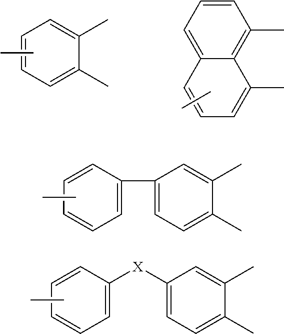
and corresponding optionally substituted structures, wherein X is selected from —O—, —C(O)—, —CH₂—, —C(CF₃)₂—, and —(CF₂)_{q}—, and q is an integer from 1 to 5; and
R is selected from the group consisting of the following structures: 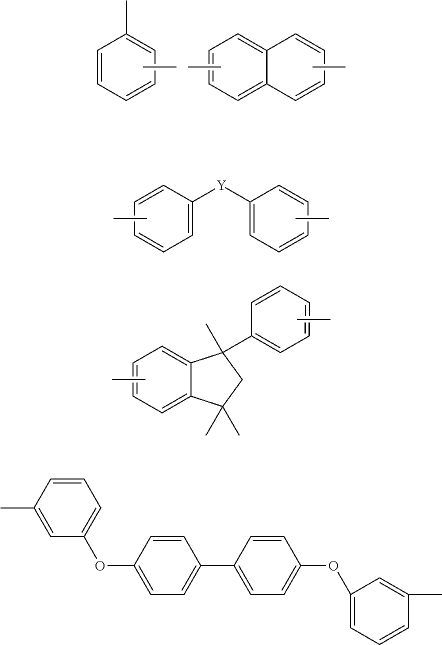
and corresponding optionally substituted structures, wherein Y is selected from —O—, —S—, —SO₂—, —CH₂—, —C(O)—, —C(CF₃)₂—, —(CF₂)_{q}, and q is an integer from 1 to 5.

18. The composition according to claim 5, wherein AₙXₘ is ZnS.
